(19) United States
(12) Patent Application Publication
(10) Pub. No.: US 2004/0118023 A1
(43) Pub. Date: Jun. 24, 2004

(54) Structure of an ornamental article with light variations

(76) Inventor: Kevin Lee, Taipei (TW)

Correspondence Address: Kevin Lee, PO Box 82-144, Taipei, TW

(21) Appl. No.: 10/323,780

(22) Filed: Dec. 20, 2002

(51) Int. Cl. G09F 19/00

(52) U.S. Cl. 40/406; 40/439

(57) ABSTRACT

A structure of an ornamental article with light variations is disclosed. The ornamental article comprises a main holding body enclosing an appropriate amount of a filing solution, wherein the filing solution contains evenly distribution of a plurality of light-reflective plate bodies; a pump having an outlet and an inlet, secured within the main holding body; and a guiding tube having one end connected to the outlet of the pump, and the other end of the guiding tube connected to the inlet of the pump, or directly recycled to the main holding body, whereby the pump causes the filing solution to flow within the guiding tube and the light-reflective plate bodies reflect light from each direction and angle when the filing solution is flowing within the tube, producing light flickering and glittering effect.

### BACKGROUND OF THE INVENTION

a) Technical Field of the Invention

The present invention relates to an ornamental article, and more particularly to article which provides ornamentation as well as light-reflecting effect.

b) Description of the Prior Art

Recently available flickering lighting (for instance Christras lighting, ornamental light devices for advertisement) is provided with a plurality of small flickering light bulbs connected with wires in series. A simple control device is used to control the flickering bulbs to generate the illumination at differing time. Due to the high usage of flickering bulbs, the current needed is large and the conventional ornamental lighting device is environment unfriendly. In addition, the flickering pattern is too simple and monotonous. When there is a bulb failed to flicker, there is a notch formed on the entire ornamental lighting device. Thus, the overall design of the ornamental lighting device is affected.

Another type of ornamental lighting device which is commonly found in the market is a lighting device having a transparent box containing a specific amount of liquid. The liquid contains grease of differing colours or with a plurality of light-reflective plates, and the bottom of the container is mounted with a light source with can produce heat. The heat energy will cause the liquid to cause a convention current to the liquid within the container and the differing colour grease and the light-reflective plates will afloat and flow and therefore a flickering effect under a light source is obtained. However, the drawbacks of the above conventional ornamental lighting device are that the container has to be specific and elongated tube of a cavity space is not suitable. Accordingly it is an object of the present inventions to provide a structure of an ornamental lighting device which can overcome the above drawbacks.

### SUMMARY OF THE INVENTION

Accordingly, it is an object of the present invention is to provide a structure of an ornamental article with light variations comprising a main holding body enclosing an appropriate amount of a filing solution, wherein the filing solution contains evenly distribution of a plurality of light-reflective plate bodies; a pump having an outlet and an inlet, secured within the main holding body; and a guiding tube having one end connected to the outlet of the pump, and the other end of the guiding tube connected to the inlet of the pump, or directly recycled to the main holding body, whereby the pump causes the filing solution to flow within the guiding tube and the light-reflective plate bodies reflect light from each direction and angle when the filing solution is flowing within the tube, producing light flickering and glittering effect.

Yet another object of the invention is to provide a structure of an ornamental article with light variations, wherein the main holding body has one lateral side being an opening which is appropriately covered by a covering body.

A further object of the present invention is to provide a structure of an ornamental article with light variations, wherein the light-reflective plate bodies are thin metal plates or plastic plates.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the entire structure of the present invention.

FIG. 3 schematically shows another configuration in accordance with the present invention.

FIG. 4 shows another preferred embodiment in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

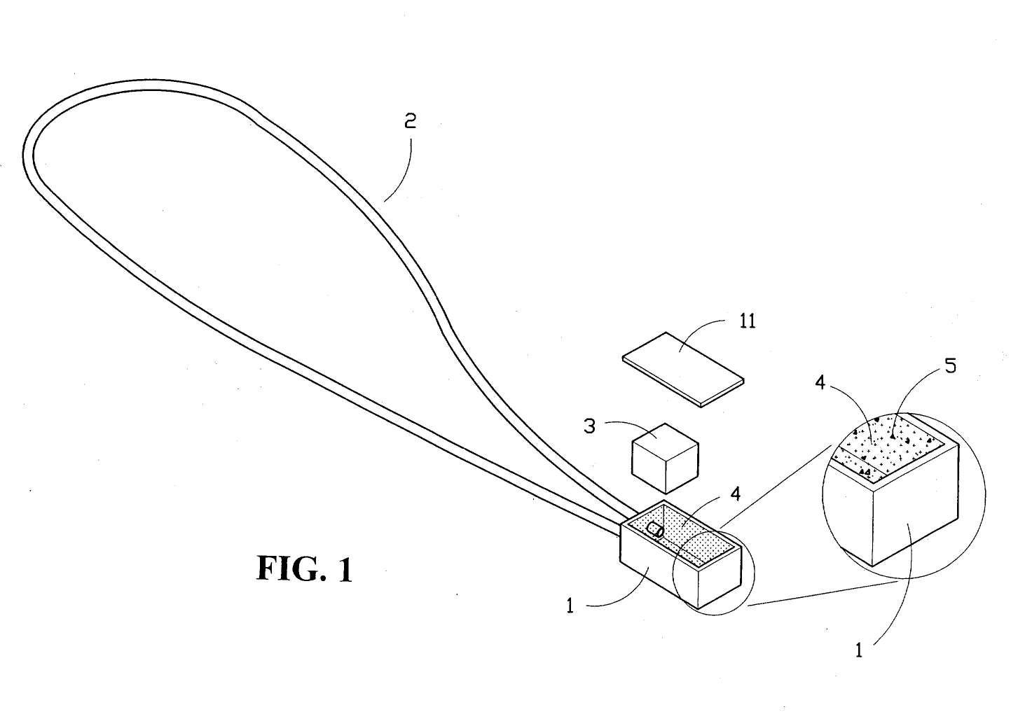

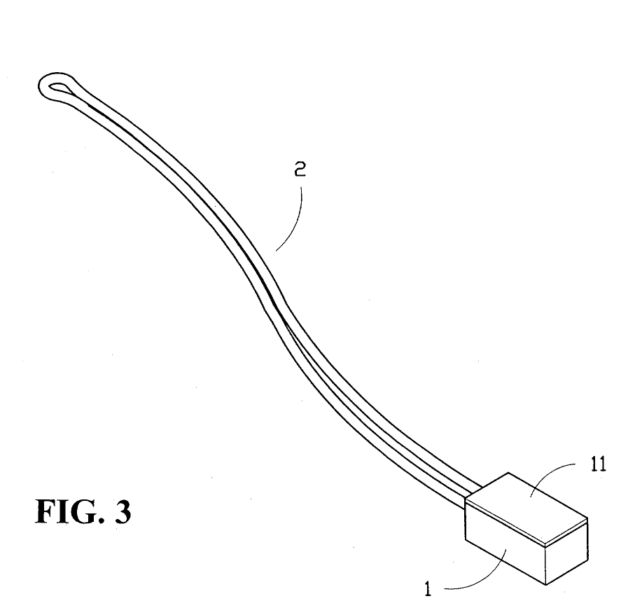

Referring to FIGS. 1 to 3, there is shown a structure of an ornamental article with light variations comprising a main holding body 1 containing a pump 3 and enclosing an appropriate amount of a filing solution. The filing solution contains evenly distribution of a plurality of light-reflective plate bodies 5, for instance thin metal plate or plastic plates. The pump 3 is connected to an outlet and an inlet, secured within the main holding body 1 and a guiding tube 2 having one end connected to the outlet of the pump 3, and the other end of the guiding tube 2 is connected to the inlet of the pump 3, or directly recycled to the main holding body 1, whereby the pump 3 causes the filing solution to flow within the guiding tube and the light-reflective plate bodies 5 reflect light from each direction and angle when the filing solution is flowing within the tube 2, producing light flickering and glittering effect.

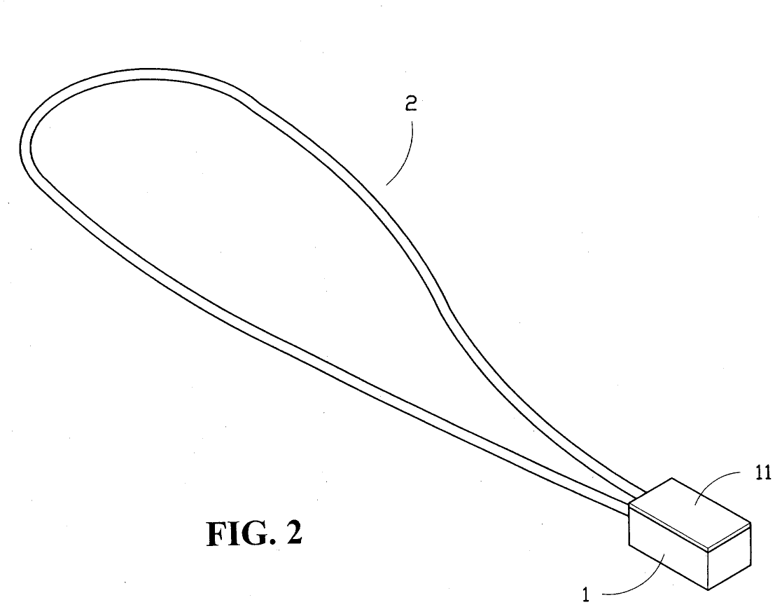

In combination, the guiding tube 2 can be extended outward to form a mount (as shown in FIG. 2) and the two ends are bonded to form two parallel extensions with different configuration.

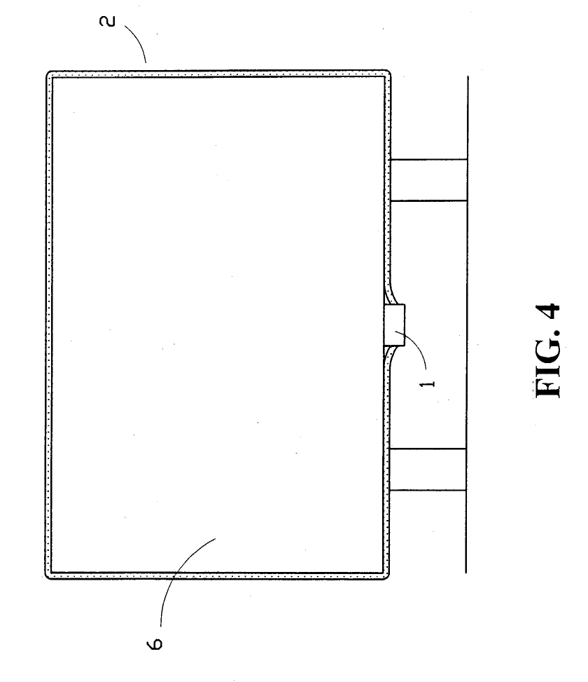

FIG. 4 shows a preferred embodiment of the present invention. As shown, the guiding tube 2 surrounds the edge of the brand 6 and the guiding tube 2 can be mounted to the circumferential edge whether the amendment is right or wrong. The pump 3 that provided will cause the move of the parallel arranged of brand 6. Therefore the guiding tube 2 surrounds the reflective light plate and light from different and angle will cause the edge of the grand with a structure having a friction and the efficient between the brands. The refractive items can produce a flickering effect to the environment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of an ornamental article with light variations comprising a main holding body enclosing an appropriate amount of a filing solution, wherein the filing solution contains evenly distribution of a plurality of light-reflective plate bodies; a pump having an outlet and an inlet, secured within the main holding body; and a guiding tube having one end connected to the outlet of the pump, and the other end of the guiding tube connected to the inlet of the pump, or directly recycled to the main holding body, whereby the pump causes the filing solution to flow within the guiding tube and the light-reflective plate bodies reflect light from each direction and angle when the filing solution is flowing within the tube, producing light flickering and glittering effect.

2. The structure of claim 1, wherein the main holding body has one lateral side being an opening which is appropriately covered by a covering body.

3. The structure of claim 1, wherein the light-reflective plate bodies are thin metal plates or plastic plates.
